(19) United States
(12) Patent Application Publication
(10) Pub. No.: US 2008/0197614 A1
(43) Pub. Date: Aug. 21, 2008

(54) INTEGRATED BALLAST APPARATUS FOR A VEHICLE

(76) Inventors: Andrew P. Connors, Reston, VA (US); Marc A. Rossi, West Palm Beach, FL (US)

Correspondence Address: ROSSI, KIMMS & McDOWELL LLP., P.O. BOX 826, ASHBURN, VA, 20146-0826, US

(21) Appl. No.: 11/676,034

(22) Filed: Feb. 16, 2007

(51) Int. Cl. B60S 9/00; B60P 3/22; B60K 15/03

(52) U.S. Cl. 280/759; 180/89.1; 180/314; 280/830; 296/181.1

(57) ABSTRACT

A ballast apparatus adds ballast above or adjacent to the driven wheels of a vehicle, wherein the ballast can be easily loaded and unloaded without taking up valuable cargo space of the vehicle. The ballast apparatus is preferably integrated with the structure of the vehicle and includes at least one ballast container located within a body cavity of the vehicle, wherein the ballast container includes at least one inlet and at least one outlet.

### BACKGROUND OF THE INVENTION

1. Field of the Invention

The present invention relates to ballast systems for pickup trucks and other vehicles, and more particularly, to one or more ballast containers that are filled with a ballast and that reside within a body cavity of a vehicle above or adjacent to the driven wheels.

2. Description of the Prior Art

Automobiles are susceptible to loss of traction in less than ideal road conditions, most notably in wintry or rainy weather. Moreover, pickup trucks and those with rear-wheel drive are especially susceptible to this phenomenon and require added weight in the rear of the vehicle in order to improve the vehicle's traction. Accordingly, people often fill their trunks or pickup beds with sand bags or other heavy objects. Such objects are undesirable because they are cumbersome to load and unload, they take up valuable cargo space, and their location is not necessarily near the driven wheels. It is therefore desirable to have a vehicle apparatus which adds additional weight without cumbersome loading and unloading and does not take up the cargo space of the vehicle.

U.S. Patent Published Application No. 2004/0119274 A1 discloses a bed liner with a compartmented ballast chamber which resides between the two rear-wheel wells of a pickup truck and lies atop the bed of said truck. The bed liner, by means of a hose, can be filled with up to 500 lbs. of water which provides increased traction to the vehicle. This bed compartmented ballast chamber, however, takes up cargo space, and additionally, any cargo which is placed atop or near the device risks puncturing it. Furthermore, the device is relatively difficult to empty after use, and the weight is not distributed over the driven wheels of the vehicle.

U.S. Pat. No. 4,482,169 discloses a traction rack which fits between the rear wheels of a pickup truck. Lead weights attached to the rack provide the weight necessary to increase traction. The device does align weight near the wheels of the vehicle, but it is cumbersome to load and unload.

U.S. Pat. No. 4,190,281 discloses a ballast for pickup trucks which fits along the side of a pickup bed atop the wheel wells contained within. Again, the device distributes the weight in a generally desirable location; however, the device is cumbersome to load and unload.

In view of the above, it would be desirable to provide a ballast apparatus that adds ballast above or adjacent to the driven wheels of a vehicle, wherein the ballast can be easily loaded and unloaded without taking up valuable cargo space of the vehicle.

### SUMMARY OF THE INVENTION

The invention provides a ballast apparatus that adds ballast above or adjacent to the driven wheels of a vehicle, wherein the ballast can be easily loaded and unloaded without taking up valuable cargo space of the vehicle and is preferably integrated with the structure of the vehicle. More specifically, the invention provides a ballast apparatus that includes at least one ballast container located within a body cavity of the vehicle, wherein the ballast container includes at least one inlet and at least one outlet. The ballast container is located above at least one drive wheel of the vehicle. Preferably the ballast container is integrated with the vehicle, such that it is not necessary to load or unload the ballast container into the vehicle. In one preferred embodiment, the ballast container is manufactured from a flexible material. The use of a flexible material is particularly advantageous when a liquid ballast is used and the liquid ballast is susceptible to freezing in bad weather conditions. Alternatively, the ballast container is manufactured from a rigid material. The use of a rigid material is particularly advantageous when a solid ballast is used, although a solid ballast may also be employed with a flexible material. Similarly, a liquid ballast can be employed with a rigid material in cases where the liquid ballast has a low freezing point. Finally, the ballast container may be coupled to an operating system of the vehicle, such that the ballast container serves as a reserve reservoir for a fluid required by the operating system.

### BRIEF DESCRIPTION OF THE DRAWINGS

A fuller understanding of the present invention will become apparent upon consideration of the following detailed description taken in connection with the accompanying drawings, wherein:

FIG. 1 is a cut-away view of the rear fenders of a vehicle in which two ballast containers are positioned above and adjacent to the rear wheels of a vehicle; and

FIG. 2 is a side view of two internal ballast containers positioned above and adjacent the rear wheels of a vehicle.

### DETAILED DESCRIPTION OF THE PREFERRED EMBODIMENTS

The present invention preferably consists of one or more ballast containers located above or adjacent to the driven wheels of the vehicle, wherein the ballast containers reside within a body cavity of the vehicle. Preferably, there are first and second ballast containers which reside over first and second driven wheels, respectively. These ballast containers are in addition to conventional containers which reside on the vehicle, namely the wiper fluid reservoir, the oil reservoir, the gasoline tank, and the like which hold various fluids. Each ballast container is preferably held in place by a bracketing apparatus or through other conventional fasteners such that the ballast container is essentially integrated with the vehicle body. Each ballast container includes one or more inlets to enable the ballast container to be filled with ballast, and one or more outlets for emptying the ballast from the container.

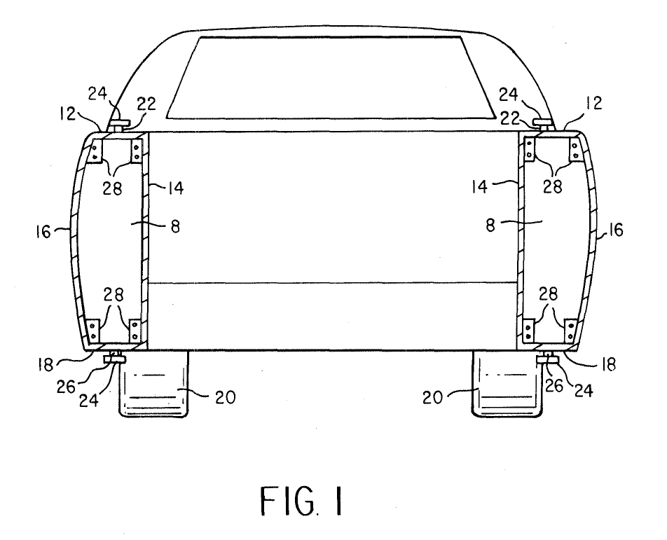

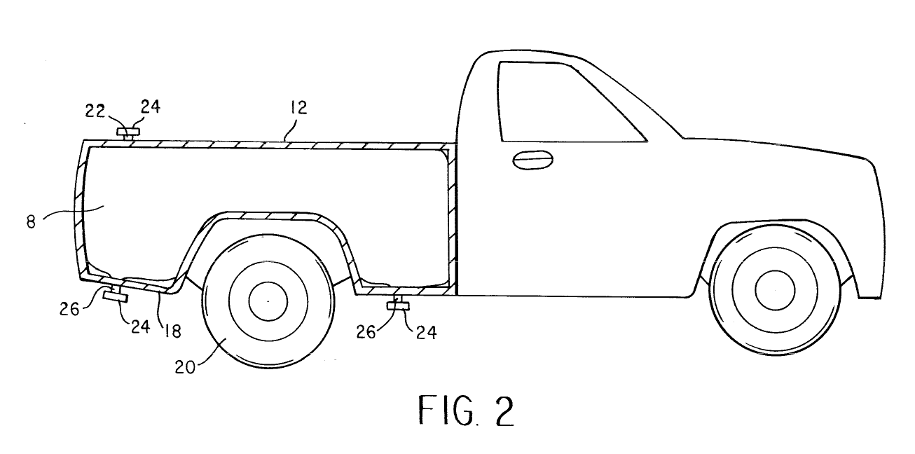

The body cavity of the vehicle is preferably defined by one or more structural elements of the vehicle which define an interior space, and may include both sections of the vehicle which are fully enclosed by structural elements and those sections of the vehicle which are not, so long as the structural elements form an interior space at least partially enclosed by the structural elements. Still further, structural elements of the vehicle may be combined with structural elements of accessory devices, such as bed liners, to form the body cavity. For example, in FIGS. 1 and 2, containers 8 reside within a body cavity 10 defined by structural elements including a top surface 12, a bed side surface 14, an outside surface 16 and a bottom surface 18 of a rear fender of a pickup truck. In this embodiment, the container 8 is fully enclosed by the structural elements and is located above the drive wheels 20 of the vehicle. As shown in FIG. 1, the container 8 is held in place by a plurality of brackets 28, although they may be held in place by other means.

Additionally, inlets 22 are provided through the top surface 12 of the body of the vehicle to permit ballast to be loaded into the containers 8. Preferably, the ballast is a liquid material, although a solid material may also be utilized. The location of the inlets 22 is not necessarily restricted to the top surface 12, but may also be provided through the side surfaces of the vehicle if so desired. In the preferred embodiment illustrated, the inlets 22 include a conventional hose connection and accept a cap 24, thereby enabling a hose to be directly connected to the inlets 22 in order to fill the container 8 with ballast.

Similarly, outlets 26 are provided that pass through the bottom surface 18 so that ballast contained in the ballast container may be easily removed through the force of gravity. Like the inlets 22, the outlets 26 also accept a cap 24 that can be easily screwed onto the outlets 22 in a conventional manner. The outlets 26 provide a significant advantage over conventional types of ballast systems by enabling ballast to be unloaded for a ballast container while the ballast container is integrated with the vehicle body.

As shown in FIG. 2, the containers 8 actually extend along the entire length of the fender of the vehicle in the illustrated embodiments, such that the containers 8 are located both above and adjacent to the sides of the driven wheels 20. It will be understood, however, that the containers 8 may be smaller than those shown and may be placed at any desired location with a defined body cavity. As just one example, the containers 8 may be limited to a location just above the driven wheels as illustrated by the dashed lines shown in FIG. 2. In the illustrated example, however, multiple outlets 26 are required in order to drain ballast from all areas of the containers 8 due to the configuration of the ballast containers 8 as illustrated.

As stated above, the ballast loaded into the ballast container 8 may be either a liquid or a solid. The containers 8 are preferably composed of a flexible material, such as a soft plastic or rubber, such that expansion may occur in the event a liquid ballast is utilized and the liquid ballast freezes. Alternatively, the containers 8 are preferably composed of a rigid material like hard plastic or metal in cases where a solid ballast is to be used. For example, a fine sand, such as a silica sand that essentially flows like water, may be added to the ballast containers instead of a ballast liquid. Still further, a liquid ballast liquid with a lower freezing temperature than water may be used with a rigid material. In any case, the containers are capable of holding a significant amount of ballast (enough to affect traction of the vehicle) and conform to the vehicle's load requirements and other necessary specifications.

The size and shape of the containers of the apparatus vary according to the specifics of the vehicle that they are integrated into. This includes the amount of space available within the body cavity of the vehicle along with maximum load considerations. Moreover, the quality of the improved traction of the vehicle depends on the amount of space within the body cavity in question. Water weighs approximately 8.34 lbs/gallon, and a gallon takes up approximately 0.13 cubic feet, so even under modest space constraints, the apparatus provides a significantly increased weight to the vehicle. For example, 1.3 cubic feet within the body cavity of a vehicle would allow for approximately 10 gallons of water, or approximately 83.4 lbs. of added weight. Additionally considering a second and equal amount of space in a symmetric portion of the vehicle, the apparatus would add approximately 170 lbs. to the vehicle. Of course, the construction of a particular vehicle may allow for more or less weight as described above.

The apparatus may also consist of one or more containers which do not reside above or adjacent to the driven wheels of a vehicle. Any body cavity of the vehicle may hold additional containers in a similar manner as those which are above or adjacent to the driven wheels of the vehicle. Moreover, the present invention encompasses containers which reside in any empty space which exists between or within the integrated components of the vehicle, like a space within a bumper.

Preferably, these embodiments are fully integrated into the vehicle so that they do not require or demand loading and unloading. Alternatively, one or more containers of any particular embodiment may be removable such that the user of the vehicle can remove said containers.

It should be appreciated that the various embodiments of the apparatus may have other uses beyond added traction. The ballast container may be coupled to an operating system of the vehicle, such that the ballast container serves as a reserve reservoir for a fluid required by the operating system. For example, the ballast containers, or portions thereof, might hold washer fluid, oil, gasoline, or the like, such as to increase the capacity of the washer, oil and fuel systems of the vehicle.

Since certain changes may be made in the foregoing disclosure without departing from the scope of the invention herein involved, it is intended that all matter contained in the above description and depicted in the accompanying drawings be construed in an illustrative and not a limiting sense.

1. A vehicle including an internal traction apparatus, the apparatus comprising:
at least one ballast container located within a body cavity of the vehicle, said ballast container comprising at least one inlet and at least one outlet;
wherein the ballast container is located above at least one drive wheel of the vehicle;
wherein the ballast container is integrated within a fender of the vehicle; and
wherein the outlet is configured such that a ballast material contained within the ballast container may immediately exit the vehicle upon removal of a cover from the outlet.

2. (canceled)

3. A vehicle including an apparatus according to claim 1, wherein the ballast container comprises a flexible material.

4. A vehicle including an apparatus according to claim 1, wherein the ballast container comprises a rigid material.

5. (canceled)
